(19) United States
(12) Patent Application Publication
(10) Pub. No.: US 2003/0026250 A1
(43) Pub. Date: Feb. 6, 2003

(54) Method and device for synchronous cell transfer and circuit-packet duality switching

(76) Inventor: Xiaojun Fang, San Jose, CA (US)

Correspondence Address: Xiaojun Fang, 1040 Winchester Blvd. #15, San Jose, CA, 95128, US

(21) Appl. No.: 10/139,581

(22) Filed: May 4, 2002

Related U.S. Application Data
(60) Provisional application No. 60/309,593, filed on Aug. 3, 2001.
(60) Provisional application No. 60/310,401, filed on Aug. 7, 2001.
(60) Provisional application No. 60/315,206, filed on Aug. 27, 2001.
(60) Provisional application No. 60/326,749, filed on Sep. 29, 2001.

(51) Int. Cl. H04L 12/50; H04L 12/28

(52) U.S. Cl. 370/386; 370/404

(57) ABSTRACT

This invention provides a method and device for generating and transporting synchronous cells and switching them with circuit-packet duality switch. Different traffics are carried by the synchronous cells and switched by the circuit-packet duality switch (100). These synchronous cells are synchronously mapped into 125 μs frames and transported over synchronous cell switched network (250). Each synchronous cell in the 125 μs frame is both a time slot of the frame and a fixed size packet. A synchronous cell (12) is switched by the circuit-packet duality switch (100) either in circuit switching manner by treating the cell as a time slot, or in packet switching manner by self-routing using connection IDs in the cell header.

### CROSS-REFERENCE TO RELATED APPLICATIONS

This application claims the benefit and is a continuation-in-part of U.S. Patent Application Ser. No. 60/309,593, filed on Aug. 3, 2001, U.S. Patent Application Ser. No. 60/310,401, filed on Aug. 7, 2001, U.S. Patent Application Ser. No. 60/315,206, filed on Aug. 27, 2001, and U.S. Patent Application Ser. No. 60/326,749 filed on Sep. 29, 2001.

### FIELD OF THE INVENTION

This invention relates generally to telecommunication networking, in particular to telecommunication transport and switching systems. More specifically, it relates to the efficient method and device to transport both circuits and packets seamlessly across high-speed optical network using a circuit-packet duality switching and synchronous cell transfer scheme.

### BACKGROUND AND SUMMARY OF THE INVENTION

Traditional transport network is based on circuit switching. Synchronous Optical Network (SONET) and Synchronous Digital Hierarchy (SDH) network are standard circuit switching optical networks today, where a high-speed SONET/SDH signal consists of many low speed STS-1/STM-0 tributaries that are time division multiplexed (TDM) together. Connections in the circuit-switching network are fixed bandwidth pipes, and these pipes can be either permanent or dynamically established. Circuit switching network is always connection-oriented, which means that end-to-end circuit connection has to be established before information can be sent. Bandwidth of this end-to-end circuit is dedicated to the service during the use. Voice network is a typical circuit switching network.

Computer data network is based on Internet protocol (IP) and uses packet switching to transport data. This is because traffic pattern in the data network is bursty, to use a permanent circuit to transport data is very inefficient. To increase network utilization efficiency, IP datagram is segmented into small pieces called packets. Data traffic is sent packet-by-packet across the network and switched by packet switches. The packet switch uses source and destination IDs carried in the packet header and the routing table to determine what port the packet should be forwarded to. In this way, packets are delivered to the destination without a connection, and a lot of bursty data connections share the same physical pipe to achieve statistical multiplexing gain. This statistical multiplexing mechanism makes the packet switching network very efficient to transport bursty data traffic. With increasing deployment of the Internet, the Internet Protocol (IP) traffic is becoming the dominant traffic format in future public networks. As a result, the public telecommunication networks are evolving from the traditional circuit-switching network to new packet-switching network.

The packet-switching network has two operation modes, connectionless and connection-oriented. The connectionless operation does not need the signaling process to set up a connection for the service, packets are routed hop by hop across the network based on source and destination IDs and routing protocols, such as such as OSPF, BGP, IS-IS, etc. The connection-oriented packet switching network requires established connections for data transmission, and the connections can be either permanent set by provisioning or dynamic set by signaling. Asynchronous Transfer Mode (ATM) network is a connection-oriented packet-switching network, while traditional IP network is a connectionless packet-switching network. To assure certain quality of service (QoS) agreement, connection-oriented service with bandwidth reservation is required. Traffic performance in the connectionless network is best effort, the network cannot guarantee quality of service (QoS). The connectionless network has to be lightly loaded with data traffic in order to support certain level of QoS performance, so the bandwidth utilization efficiency is low.

Multi-protocol label switching (MPLS) and resource reservation protocol (RVSP) are developed for the IP network as a traffic-engineering tool to support high quality connection-oriented services within the connectionless best-effort IP network. The MPLS protocol is to replace the ATM layer in the data network by mimic ATM functions in the IP layer, the connection set by the MPLS and RSVP is called a label switch path (LSP). Both the ATM and MPLS are layer 2 protocols to support traffic engineering for data networks. One difference between the MPLS based IP network and the ATM based IP network is that the MPLS network directly switches variable size IP packets based on the MPLS labels carried in the packet header, while the ATM network switches fixed size packets called ATM cells (53 bytes). Because each MPLS labeled IP packet still carries unique source and destination address, several LSPs can be merged into one and separated at the destination. This LSP merge function is equivalent to circuit aggregation in circuit switching networks. An IP switch router can hence perform transport layer switching using the MPLS labels and also perform service layer switching using the source and destination address for connectionless services. The ATM network is always connection-oriented, it transports and switches asynchronous 53-byte cells and it can also perform both transport layer switching and service layer switching. To support TDM circuits in packet switching network is accomplished by circuit-emulation. Jitter and delay control for circuit emulation service is difficult because of the tight QoS requirements. This high QoS requirement makes the packet switching network very complex and expensive.

Public network topology is mainly SONET or SDH ring today. Voice and data traffic are aggregated into a fixed bandwidth circuit pipe and transported by the SONET/SDH network. Packet over SONET/SDH (POS) has been developed to remove the ATM and SONET/SDH circuit connection layers by putting all networking functions in the IP layer. The main motivation for doing this is because the SONET/SDH layer only provides fixed bandwidth TDM pipes, and the statistical multiplexing efficiency for mapping data traffic into several small groups is not as good as mapping into a big group. In additional, the high transmission line rate of the wavelength pipe also makes the packet processing delay and jitter lower. The drawback of this POS approach is that all services are carried through packets. The traffic engineering in IP network is very difficult, and the network has to be lightly loaded to prevent sudden traffic bursts from degrading the QoS of the existing premium services. To use this over-engineered networking scheme to achieve reasonable QoS guarantee results in big network resource waste. Other methods are also developed to tackle the same networking challenge, these include ATM overlay or MPLS, synchronous dynamic transfer mode (DTM), and resilient packet ring (RPR), etc. Current ATM network is designed to assure service quality by enforcing quality of service (QoS) contract over the connection, which increases complexity and transmission tax for the best-effort IP traffic. The MPLS used in POS is to support traffic engineering for guaranteed premium services. When the percentage of premium services increase, the connectionless based IP network become inefficient even with MPLS. RPR is an Ethernet LAN extension into metro ring, and it shares the same problems as POS and MPLS based packet switching system. DTM is a circuit-switching scheme with fast connection reconfiguration capability. It is against the packet-switching network trend.

The main advantages of the circuit-switching scheme are its low processing delay, zero jitter, zero cell/packet loss, and network management simplicity. There is no need for traffic engineering in the circuit switching network. The main drawback of the circuit switching network is its poor bandwidth utilization efficiency for bursty services. Bursty traffics have to be multiplexed first and then mapped into a single circuit to smooth out the traffic for transport. The main advantages of the packet switching are its statistical multiplexing gain for bursty traffics and its flexible bandwidth management capability. The main drawbacks are the traffic engineering complexity for guaranteed services and degraded performance for TDM services. The best compromise one can make today for network is to use circuit switching for transport in the public networks and packet switching for services in edge networks.

To ensure good quality of service and to ease traffic engineering effort for data services within an unified network are the keys for good networking schemes. In view of the foregoing, it would be an advance in the art to have a new type of transport and service switching mechanism that combines the advantages of both the circuit switching and packet switching.

The present invention is a circuit-packet duality (CPD) switching and synchronous cell transfer networking (SCN) method and architecture. The synchronous cell transfer network continuously transmits 125-microsecond long frames. Each frame has fixed number of transport overhead bytes and fixed number of user time slots (sub-frames), and each slot carries a user cell. There are two types user cells supported in the SCN, slim-header cells and standard cells. The slim-header cell has a short header that does not contain connectivity IDs or it even has no header. Its payload capacity is thus increased. The standard SCN cell has a header that contains multi-layer connection IDs and OAM bits for flow control, network management and performance monitoring, etc. Standard cells are switched by the connection IDs in the cell header, in a similar way as the ATM cell switching. Because each frame is partitioned to have fixed format, the time slot sequence number in a frame is the identifier for the time slot. When a circuit connection is created, certain time slots are assigned to the connection and the slot assignment is kept in the connectivity table. Hence circuit switching can be accomplished by switching time slots based on the connectivity table. The slim-header SCN cells do not have connection IDs and hence can only be switched by the circuit-switching mechanism. The standard SCN cells can be switched in either the packet switching manner using the connection IDs, or in the circuit switching manner using the time slot sequence ID in the frame and the connectivity table. Thus, each SCN cell can be treated either as a circuit (time slot) or a packet (cell), depends on the service level agreement (SLA). Circuit-packet duality switching is used as the term to describe the unique switching scheme that a SCN cell can be switched either as a cell or as a synchronous time slot.

More particularly, the present invention is a method for traffic transport and switching based on fixed size cells/time slots, for any network topology. Cell mapping into a frame is synchronous to the frame, and transmission is synchronous to a highly accurate network clock. A SCN cell is switched by the circuit-packet duality switch either as a time slot or a cell. True circuit connections and true packet based virtual connections are both supported in the SCN, and circuit emulation is not needed. The SCN connection is transparent, it can be viewed as a dynamic bandwidth physical port or logical port for transmission. Hence a SCN connection is called virtual lightpath connection (VLC). The SCN network consists of CPD switches that build VLCs across networks efficiently and reliably.

### BRIEF DESCRIPTION OF THE FIGURES

FIG. 1 shows transmission frames and super-frames of the present invention;

FIG. 2 is a view of cell format of the present invention;

FIG. 3 is a view of cell header format;

FIG. 4 shows the format of a standard cell and a slim-header cell.

FIG. 5 is a detailed view of frame structure using OC-12 SONET/SDH emulated transmission;

FIG. 6 is a detailed view of frame structure using 8B/10B coding and Gigabit Ethernet emulated transmission;

FIG. 7 is a schematic view of a circuit-packet duality switch having multiple network side ingress and egress ports, and a number of add and drop ports that are connected to tributary interfaces;

FIG. 8 is a schematic view of a high-capacity optical network topology with circuit-packet duality switching and wavelength add and drop;

FIG. 9 shows a functional network element structure of a high-capacity circuit-packet duality switch;

FIG. 10 is a small-scale SCN ring network having centralized grant-based flow control.

### DETAILED DESCRIPTION

The present invention provides a method of transporting plurality of synchronous cells in 125 μs frames and switching these cells by circuit-packet duality (CPD) switching. Each frame of the synchronous cell transfer network (SCN) contains a plurality of transport overhead bytes as well as a plurality of time division multiplexed (TDM) time slots for payload. A SCN cell is carried by a SCN slot, it has a plurality of overhead bytes in its header. The CPD switch switches each SCN cell either as a packet or as a circuit. When the SCN cell is switched as a packet, the CPD switch uses the connection identifiers carried in the cell header and the switching table to perform the switching. When the SCN cell is switched as a circuit, the CPD switch treats each cell as a time slot and uses the time slot sequence number and connectivity table to perform the switching.

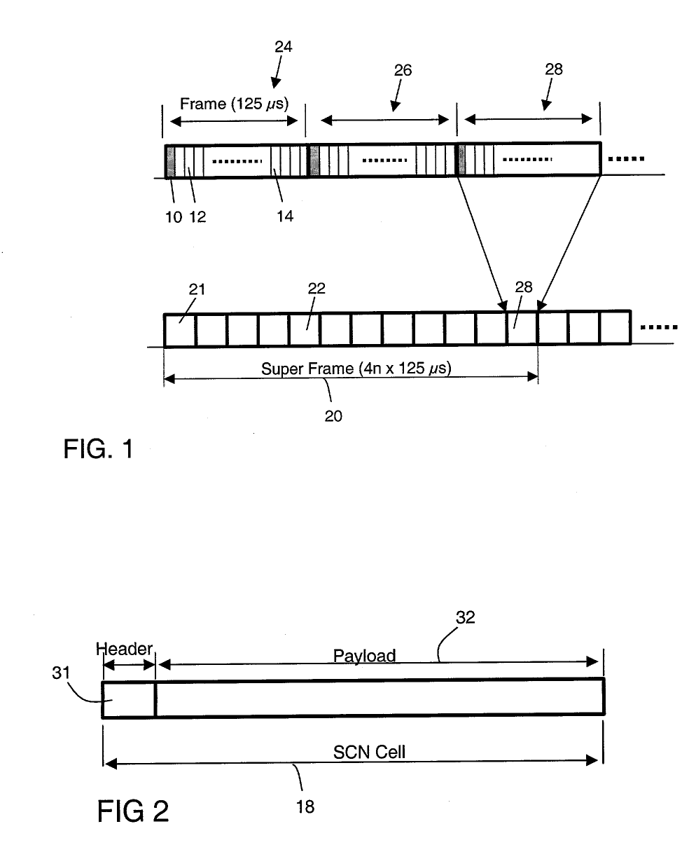

Frame transmission in the synchronous cell transfer network is similar to the frame transmission in SONET/SDH network. Consecutive SCN frames are transmitted continuously and synchronized to a highly accurate network clock, one frame per 125 μs. Each SCN frame has transport overhead area and payload area. The transport overhead area consists of one or more transport overhead slot, and the payload area consists of a plurality of payload time slots. The size of the transport overhead slot and the size of the payload time slot can be different. FIG. 1 shows the SCN frame transmission sequence and frame structure. The first frame 24 is transmitted first, followed by the second frame 26 and the third frame 28. The first frame 24 begins with a transport overhead slot 10 followed by a plurality of payload slots 12, 14, etc. Each payload slot contains its own overhead (header), it can be viewed as a cell or a sub-frame. These payload slots are used to carry user data cells and OAM (operation-administration-management) cells. The OAM cell is used for network management and flow control for cell based virtual connections. The first byte of the transport overhead slot 16 in frame 26 is transmitted immediately after the end of the last byte of the last slot in the previous frame 24, and so on. Each 125 μs frame is a fundamental SCN frame. Super-frame 20 can be constructed using 4n times of the fundamental frames, where n is a positive integer. Period of the super-frame 20 is 4n×125 μs, and each fundamental SCN frame is identified by a multi-frame sequence indictor byte in the frame transport overhead slot.

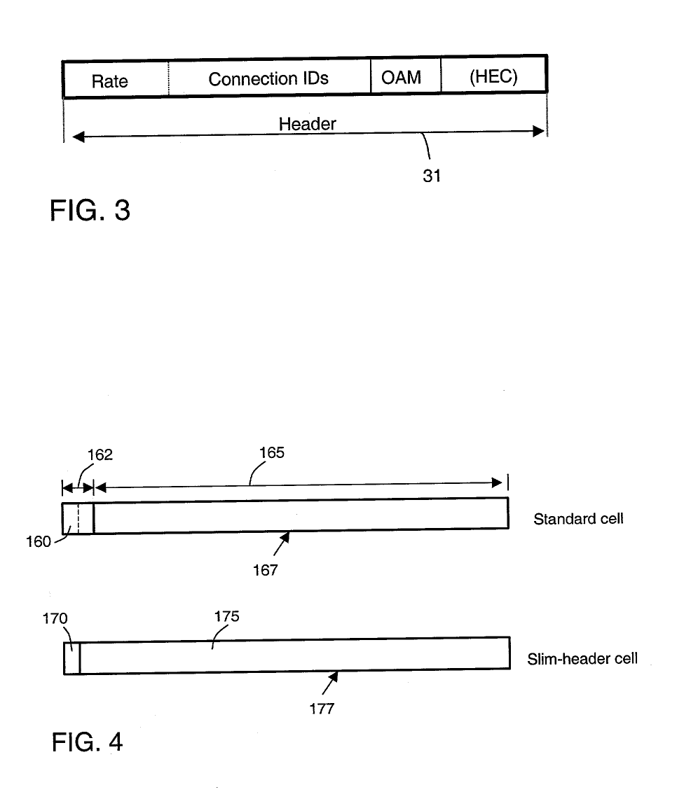

Each SCN payload time slot carries a SCN cell. All SCN cells have the same size and are mapped synchronously to the frame. Each SCN frame has fixed number of cells that are aligned within the payload area of the frame, and the alignment arrangement is identical for all frames. The SCN cell/sub-frame has header and payload area. FIG. 2 shows the structure of a SCN cell 18, which has header 31 and payload area 32. There are two types of SCN cells, as shown in FIG. 4, the standard SCN cell format 167 and the slim-header SCN cell format 177. The standard cell header 31 contains information for connection identification and management. FIG. 3 shows the cell header structure of a SCN cell. The header 31 contains bits for rate adaptation, connection identifiers (IDs), priority indicator, flow control, performance monitoring, header error control (HEC), etc. Not all these header bits are used for each cell. For example, the area for rate adaptation bits in one cell can be used for connection identifiers in another cell. Unlike the ATM network that has only two logical layers of connection IDs (i.e., the virtual circuit identifier (VCI) and the virtual path identifier (VPI)), the standard SCN cell supports multiple layers of connection IDs to address traffic aggregation need in packet switching networks, one connection ID per logical layer. This multi-layer connection ID method makes the CPD switching scalable and easy to implement for packets.

FIG. 4 shows the two types of SCN cells, the standard SCN cell 167 and the slim-header SCN cell 177. The slim-header cell 177 has a short header 170 (which can be null) for circuit connections. Hence payload capacity 175 in the slim-header cell is higher than the payload capacity 165 in the standard cell 167. The standard cell header 162 contains multi-layer connection IDs and other OAM bits for flow control and PM, etc. Rate adaptation is not required for the packet switched cells. When the standard cell 167 is treated as a circuit, rate adaptation is through inserting and removing idle cells or by adding adaptation bits 160 into header 162. Both the slim-header cells and the standard cells have the same cell length of L bytes.

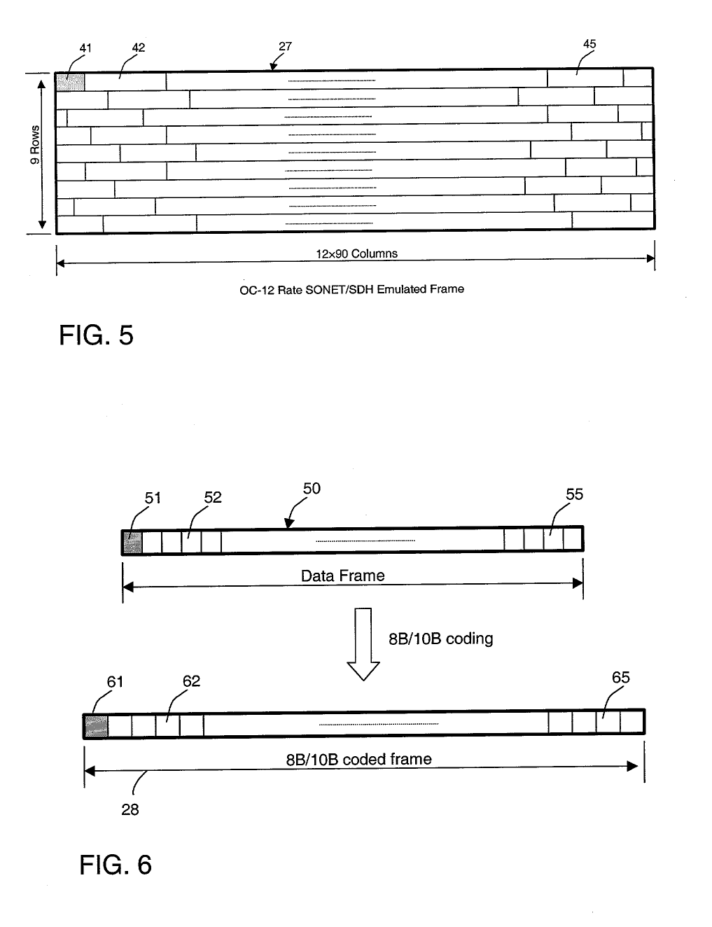

FIG. 5 shows a detailed SCN frame structure that is based on OC-12 SONET/SDH frame emulation. The frame 27 has 9 rows and 12×90 columns of bytes, 9,720 bytes in total. There are one transport overhead slot 41 at the beginning of the frame 27, and a plurality of payload slots 42, 45, and etc. Transmission sequence is row by row, from left to right. Because each L-byte payload time slot is viewed as by a SCN cell/sub-frame, the maximum number of cells a frame can hold is the integer part of 9720/L. The reminder of the 9720/L can be used for the transport overhead slot. The L-byte slots can be used for carrying additional transport overhead when necessary. As an example, if L=164 bytes, the OC-12 SONET/SDH emulated frame will have 59 payload slots, and a 44-byte transport overhead slot 41. The transport overhead slot 41 begins with SONET/SDH framing bytes for frame synchronization. Each 164-byte slot is mapped with a 164-byte SCN cell, and hence each frame contains 59 cells. Higher rate SCN frame can be constructed by slot-interleaving of multiple lower rate SCN frames. If OC-12 rate is assumed to be the lowest SONET/SDH emulated SCN rate, an OC-48 rate SONET/SDH emulated SCN frame can be constructed by slot-interleaving four OC-12 rate SONET/SDH emulated SCN frames. OC-192 and OC-768 SONET/SDH emulated SCN frames can also be formed in a similar way. The slot size L can be any integer number between 53 and 810, depends on applications. The number 164 is used for L in all analysis in this invention for simplicity.

Mapping SCN cells into SONET/SDH synchronous payload envelop (SPE) is possible too, but the SPE area within the SONET/SDH frame should be fixed, not floating. Also the SONET/SDH SPE should take integer number of cells, and the arrangement of the cells within the SPE should be fixed. If the SCN cells are mapped into SONET/SDH SPE area, it becomes a concatenated SONET/SDH signal, but each SCN slot serves as a physical connection within the SONET/SDH pipe.

FIG. 6 shows another 125 μs SCN frame structure by emulating 8B/10B coded Gigabit Ethernet (GigE) signal. Although the selection of the slot size is flexible, the same 164-byte slot size is used here. This is because if both the SONET/SDH emulated SCN and the GigE emulated SCN have the same cell format, interworking between the two types of networks is easier. Each 125 μs frame of the 1 Gbps data stream contains 15,625 bytes and each byte is 8B/10B encoded to a 10-bit symbol. For L=164 bytes, each 125 μs GigE emulated SCN frame has 95 164-byte payload slots plus a 45-byte transport overhead slot. FIG. 6 shows a GigE emulated SCN frame 50 that has a transport overhead slot 51, and payload slots 52, 55, etc. After the 8B/10B coding, each byte in frame 50 becomes a 10-bit symbol in frame 28. The 45-byte transport overhead slot 51 becomes the 45-symbol transport slot 61, and the 15,625-byte frame 50 becomes the 15,625-symbol frame 28. The transport overhead slot 61 begins with framing pattern for frame synchronization.

As described previously, all SCN cells have the same size as the SCN payload slot. It is obvious that any cell that is smaller than the payload slot can be mapped into the slot too, but the bandwidth utilization efficiency will be poor. Each L-byte cell has a M-byte header and L-M bytes of payload. Take the OC-12 SONET/SDH emulated SCN frame for example with L=164, there are 60 time slots in each frame. The first slot is used as the transport overhead slot that has only 44 bytes. The rest slots are 164 bytes long payload slots, and each cell in a slot has M bytes of header. The CPD switch has frame clock and data clock. The CPD switch can locate the beginning of a frame by looking at the special framing pattern, and then by counting the number of bytes and time slots after the beginning of the frame to determine what time slot the current byte belongs to. In this way each bytes in a frame can be identified. The synchronous slot and byte allocation in the frame allows the CPD switch to perform circuit switching. If a slot is not assigned to a circuit connection, the CPD switch will look at the connection IDs in the M-byte cell header to perform packet switching. If M=5 bytes, the payload of a cell will have 159 payload bytes which can fit 3 ATM cells. Most of the bits in the cell header are used for the connection IDs. The CPD switch can also choose to use the slot sequence number to perform circuit switching if the packet services want to be treated as a circuit connection. Which switching scheme the CPD switch chooses to handle a cell depends on the service level agreement and signaling. This circuit-packet duality networking method brings high service quality, simple traffic management, statistical multiplexing and aggregation capability for data traffic. Each SCN connection, either a circuit connection or a packet virtual connection, is a transparent permanent or on-demand transmission pipe called a virtual lightpath connection (VLC). All different types of services such as IP, frame relay (FR), and Ethernet frames can be mapped transparently to the SCN connections through the PPP/HDLC/GPP/ATM adaptation. ATM cells and TDM circuits can be mapped directly to the SCN connection.

Mapping of TDM circuits into the SCN payload slots is through direct mapping into the slim-header cells. Each 164-byte cell in the 125 μs frame has data rate of 10.496 Mbps. If a slim-header SCN cell has 162 payload bytes, it can carry 6 VT1.5 circuits (162=6×27) or 4.5 VT2 circuits (162=4.5×36). Lower rate circuits can be carried through the super-frame scheme. For example n=3, each SCN super-frame will consist of 12 fundamental frames. A multi-frame indicator identifies the sequence of a frame in a super-frame, and the bandwidth of a slot in a super-frame is 1/12 of that in the fundamental frame. Higher rate circuits need several SCN cells per frame for mapping. An STS-1 or STM-0 circuit (810 bytes) needs 5 slim-header SCN cells (810=5×162) to carry. An OC-3 circuit can be carried by 15 slim-header SCN cells, and so on. These TDM circuits mapped into the slim-header cells are circuit switched to different output ports according to slot sequence ID and connection table. Any TDM circuit connection can be added or dropped from the CPD switch in the circuit-switching manner. This makes the CPD switch possess the same functions as the SONET/SDH add-drop multiplexer (ADM) and the digital cross-connect switches (DCS), or their combination.

Mapping packet service connections into a virtual SCN connection is transparent. The SCN circuit connection or SCN virtual connection can be view as a logic port or a physical port for these packet connections. If a standard SCN cell has 5 overhead bytes and 159 payload bytes, then one cell per frame provides 10.176 Mbps payload capacity. SCN virtual connections are normally statistical, they are characterized by statistical parameters, such as peak cell rate, sustainable cell rate, cell loss ratio, delay and delay variations, etc. Bandwidth of a virtual connection can be very small, depends on how often a cell is transmitted for that connection. The virtual connection is identified by the connection ID and switched by the CPD switch to the correct output port based on the virtual connection connectivity table in the switch database.

The circuit connection is a dedicated bandwidth pipe with no cell/packet loss, negligible jitter and small delay. The packet based virtual connection shares bandwidth with other virtual connections, and traffic engineering is required to guarantee the service quality. The simplest traffic-engineering scheme is based on priority, and the switch will allow packets with higher priority pass first to avoid congestion and long delay. Typically 4 to 8 priority classes are used in the IP networks, and the circuit emulation and real time applications such as voice over IP (VoIP), have the highest priority. Unlike the packet switching network where circuit emulation has to be supported with very strict QoS requirements, the SCN network can transport TDM circuits in their native format. Hence circuit emulation is not a mandatory requirement in SCN, and the QoS goals are much easier to accomplish. This makes the traffic-engineering task much simpler than that in the ATM and IP networks. The SCN also prioritizes the cells for packet switching, a class of service (CoS) indicator can be included in the cell header for easy hardware processing. The CPD switch can also use the connection IDs and the provisioned CoS for that connection for priority indication. Although the SCN network can support connectionless packet switching, its primary application is connection-oriented applications. The connections are either permanent connections or on-demand dynamic connections. General multi-protocol label switching (GMPLS) is used as a common control plane for dynamic connection setup and dynamic network provisioning. SCN network uses GMPLS as the signaling protocol for dynamic connection setup, for both circuit connections and packet virtual connections.

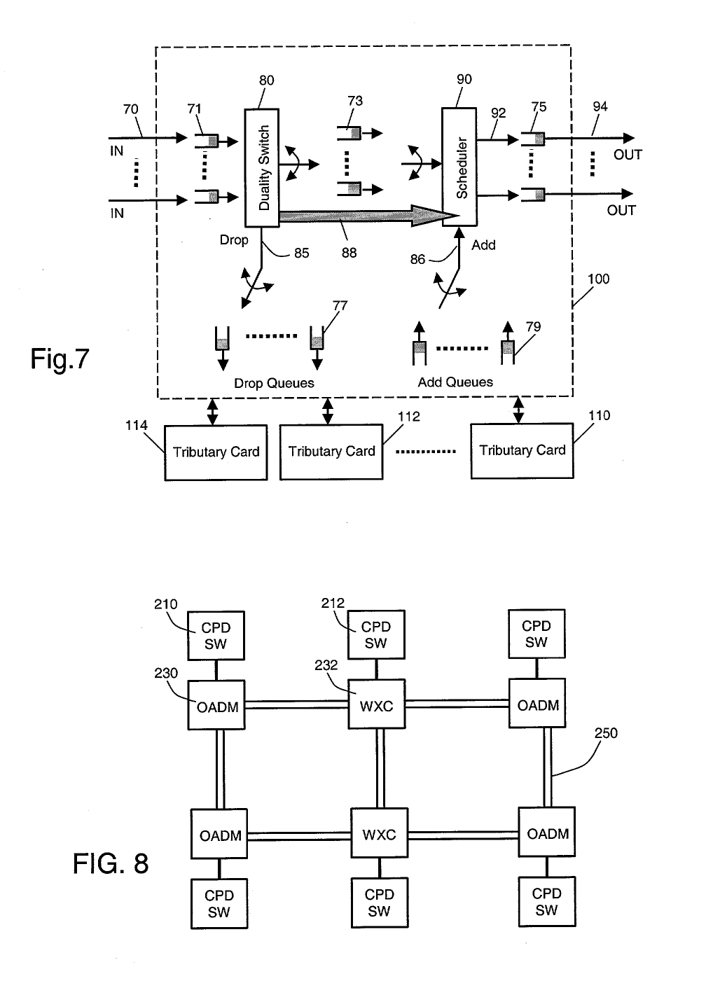

The architecture of the circuit-packet duality switch is shown in FIG. 7. The CPD switching fabric 100 has multiple ingress network interface (NNI) ports 70, and multiple egress network interface ports 94. These cells from the ingress NNI ports 70 are buffered in the ingress queues 71, at least one queue per ingress port. The CPD switch 100 first synchronizes itself with frame sync and byte/word sync, it then identifies the start of the frame and the start of slot. Certain time slots in the frame are provisioned to carry circuit cells, and the CPD switch will switch these cells directly to the correct egress ports through the TDM switching tunnel 88. Fixed delay is required in the CPD switch to map a circuit slot in the ingress frame into a pre-assigned slot in the egress frame. The worst case for this fixed delay is one frame period or 125 μs. A circuit cell that is provisioned to be dropped will be switched to the drop port 85 and then put into a proper drop queue within the drop queue group 77 and sent to tributary cards 114, 112, etc. Similarly, circuit cells that are added into SCN are sent into add queues 79 and mapped into the proper egress queues 75. In this way the circuit cells are switched by the circuit switching mechanism with zero jitter and fixed delay.

The CPD switch handles packet cells in a similar way as the ATM switch handles ATM cells. The CPD switch uses one or combination of connection IDs in the cell header to switch. The cells to be passing through are switched by the switch 80 to the intermediate stage priority queues 73, and the cells to be dropped are switched to the drop queues 77. The simplest intermediate stage queues 73 is CoS based, and more complex queues can be per connection queuing. The drop queues 77 and add queues 79 are per class per connection for access control and accounting. Cells in the intermediate stage queues 73 and in the add port queues 79 are mapped into the proper egress queues 75 by the scheduler 90 and sent to the egress ports. The tributary cards 114, 112, and 110, etc., adapt different traffic types into the SCN cells and these cells are switched by the circuit-packet duality switch 100.

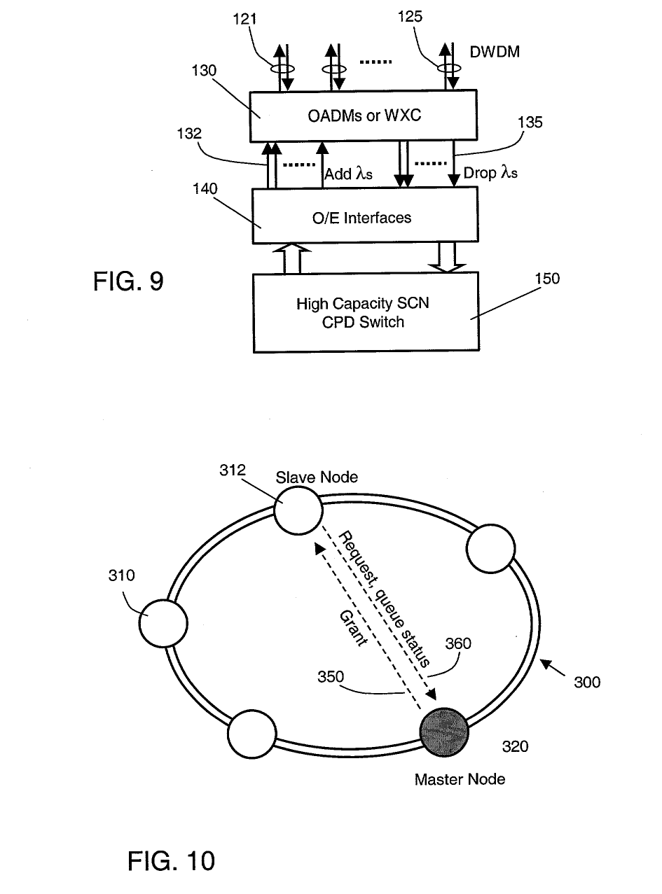

Dense wavelength division multiplexing (DWDM) is deployed in optical network to increase transmission capacity of optical fiber. A high capacity SCN network is a combination of DWDM technique and the CPD switch architecture. FIG. 8 shows a high capacity SCN network that uses optical add-drop multiplexers (OADM) 230 and wavelength cross-connects (WXC) 232 for bandwidth management and wavelength provisioning, and uses high-speed CPD switch 210, 212, for low bandwidth transport and service switching. The high capacity SCN network 250 can be of any network topology, such as ring, mesh, or point to point. The model for a high capacity SCN switch node is shown in FIG. 9. Optical wavelength connections are managed by OADMs and WXCs 130. These add/drop wavelengths 132 and 135 are terminated by O/E interfaces 140, and the O/E interfaces 140 convert signals between optical to electrical domains. The electrical signals are connected to the high capacity CPD switching fabric 150 for CPD switching.

Flow control for virtual connections in the SCN network can be distributed or centralized. For a small-size access SCN ring, the centralize flow control mechanism is more efficient because the whole ring acts as a traffic aggregation switch. FIG. 10 shows an access SCN ring 300 using centralized flow control. The ring has a master node 320 to control traffic flows on all slave nodes 310, 312, etc. The master node 320 gives grant 350 to slave nodes as the permission for transmission for each connection, the slave node 312 sends its queuing status information 360 to the master node 320 to request for grants. This request-grant mechanism forms a centralized control loop. Both grant and request can be carried by dedicated OAM cells or a dedicated slot for granting. The OAM cell carrying grants is generated by the master node and broadcasts along the ring to all the slave nodes. The central node has knowledge of all the connections, and it can give grant based on service level agreement and fairness.

In large networks, the response time for the request-grant control loop is long and this centralized flow control algorithm does not work well. Distributed flow control is preferred in large SCN networks. Each node will send cells according to the contract, and a fairness algorithm will run on top of the control algorithm to enforce fairness. Circuit connections do not need the flow control algorithm because all the traffics are static.

The invention has been described with respect to particular embodiments thereof, it is understood that numerous modifications can be made without departing from the spirit and scope of the invention as set forth in the claims.

What is claimed is:

1. A method and device of mapping and transporting synchronous cells within 125 μs frames and switching these cells with circuit-packet duality, comprising
(a) generating consecutive 125 μs frames which contains a plurality of synchronous time division multiplex payload time slots and a plurality of transport overhead slots in each frame, and
(b) assigning a cell to a payload slot; and
(c) switching a cell either as a time slot in circuit switching manner or as a packet in packet switching manner.

2. The method of claim 1, wherein the 125 μs frames are transmitted consecutively with standard SONET/SDH transmission rates or Gigabit Ethernet transmission rates.

3. The method of claim 1, wherein all the synchronous payload time slots have the same size of L bytes long.

4. The method of claim 1, wherein the first slot in the frame is a transport overhead slot beginning with framing bytes.

5. The method of claim 1, wherein the slot partition manner of the frame is fixed.

6. The method of claim 1, wherein a L-byte cell has header and payload, and the header is configurable to carry rate adaptation, connection IDs and OAM.

7. The method of claim 1, wherein the cell is circuit switched to an egress port using the sequence number of the said slot in the frame and the pre-defined connectivity table.

8. The method of claim 1, wherein the cell is packet switched to an egress port using the connection IDs carried in the cell header.

9. The method of claim 1, wherein mapping of packets into the said payload slots or into the payload area of the said cell are transparent.

10. The method of claim 1, wherein switching core contains switch and scheduler, and a plurality of ingress queues and egress queues, as well as add port queues and drop port queues.

11. The method of claim 1, wherein switching core has circuit switching tunnel to directly transfer time slots from ingress frames to egress frames.

12. The method of claim 1, wherein the traffic flow control is distributed or centralized.

13. The method of claim 1, wherein the network topology is ring, mesh, or point to point.

14. The method of claim 6, wherein the cell header has a plurality connection IDs, each for one logical network layer.

15. The method of claim 6, wherein the slim-header cell header contains no connection IDs and the header can be null.

16. The method of claim 12, wherein the flow control in synchronous cell switched access ring network is centrally controlled based on request and grant control loop.

17. The method of claim 14, wherein the connection IDs are hierarchical and used for connection aggregation.
